(19) United States
(12) Patent Application Publication
(10) Pub. No.: US 2022/0079333 A1
(43) Pub. Date: Mar. 17, 2022

(54) DRIVE SYSTEM FOR MOVING A HEIGHT ADJUSTABLE TABLETOP, TABLE HAVING SUCH A DRIVE SYSTEM, AND METHOD FOR DETECTING COLLISION OF A HEIGHT ADJUSTABLE TABLETOP

(71) Applicant: Kesseböhmer Holding KG, Bad Essen (DE)

(72) Inventors: Marcus ALBERT, Neidlingen (DE); Julian KLOTZ, Beuren (DE); Andreas NONNENMACHER, Albershausen (DE); René BARKAU, Ostercappeln (DE)

(73) Assignee: Kesseböhmer Holding KG, Bad Essen (DE)

(21) Appl. No.: 17/475,404

(22) Filed: Sep. 15, 2021

(30) Foreign Application Priority Data
Sep. 15, 2020 (DE) 10 2020 211 550.8

(51) Int. Cl. A47B 9/10

(52) U.S. Cl. CPC A47B 9/10; A47B 2200/0062; A47B 2200/0056

(57) ABSTRACT

A drive system (2) for moving a height adjustable tabletop (3) of a table (1) comprises a drive device (4) configured to the move the tabletop (3), a drive control device (5) configured to control the drive device (4), an acceleration sensor (6), and an evaluation unit (7). The acceleration sensor (6) is configured to synchronously follow a motion of the tabletop (3), to detect an acceleration of the sensor motion, and to transmit an acceleration signal corresponding to the sensor motion to the evaluation unit (7). The evaluation unit (7) is configured to evaluate the acceleration signal of the acceleration sensor, to determine a presence of a collision by means of acceleration values exceeding a threshold, and to output a collision signal to the drive control device (5) when the presence of a collision is determined.

### RELATED APPLICATION

This application claims the benefit of priority of Germany Patent Application No. 10 2020 211 550.8 filed on Sep. 15, 2020, the contents of which are incorporated herein by reference in their entirety.

### FIELD AND BACKGROUND OF THE INVENTION

The invention relates to a driving system for moving a height adjustable tabletop, a table having such a drive system, and a method for detecting collision of a height adjustable tabletop.

In the state-of-the-art, tables having height adjustable tabletops adjusted by means of a drive are known. Thereby, there is the problem that a collision between the tabletop and other objects can occur, whereby the table or the other object can be damaged or, also, parts of bodies of human beings can be hurt, for example, by clamping.

Due to this reason, there is a procedure for collision recognition based on a force measurement by deformable or compressible materials, wherein the deformation or compression are transformed into electric measuring signals by suitable sensors.

Moreover, as a further procedure, there is the measuring of the electrical supply current of the drive motors. This current depends on the force affecting the tabletop. When a collision occurs, this current increases rapidly, whereby this behavior can be used for recognition of collisions.

However, these procedures are imprecise and sluggish so that a drive of the height adjustable tabletop can answer only late or unreliably to a collision.

The object underlying the invention is therefore to eliminate the disadvantages in the state-of-the-art and to provide a drive system, a table, and a method for moving a height adjustable tabletop of a table which promptly and reliably answer to a collision.

### SUMMARY OF THE INVENTION

The object is achieved by a drive system according to claim 1, a table according to claim 9, and a method according to claim 10. Advantageous further developments are included in the dependent claims.

According to an aspect of the invention, a drive system for moving a height adjustable tabletop of a table comprises a drive device configured to move the tabletop, a drive control device configured to control the drive device, an acceleration sensor and an evaluation unit. The acceleration sensor is configured to synchronously follow a motion of the tabletop, to detect an acceleration of the sensor motion, and to transmit an acceleration signal corresponding to the sensor motion to the evaluation unit. The evaluation unit is configured to evaluate the acceleration signal from the acceleration sensor, to determine presence of a collision by means of acceleration values exceeding a threshold, and, when the presence of a collision is determined, to output a collision signal to the drive control device.

By the evaluation of the acceleration signal, contrary to the force measurement and the measurement of the supply current, the collision can already be determined at a minimum deformation without a delay by necessary deformations or compressions of additional materials for detecting the collision, on the one hand. On the other hand, no motor current is used for detecting the collision so that, additionally to the direct determination since response times of the electric motor are not to be considered, also collisions when using other kinds of drives, for example, a hydraulic drive, can be determined.

According to an advantageous implementation of the drive system, it comprises an electric drive motor and a transmission configured to convert a rotational motion of the electric drive motor into a linear motion of the drive device.

By the provision of the electric drive motor and the transmission for converting the rotational motion of the electric motor into the linear motion of the drive device, an exact determination of the behavior of the drive device is possible. Thereby, for example, velocities or accelerations can be determined exactly.

In a further advantageous implementation of the drive system, when a height adjustment of the tabletop happens in an adjustment direction, the acceleration sensor is configured to detect an acceleration in the adjustment direction, and the evaluation unit is configured to evaluate acceleration signals of the acceleration sensor transmitted corresponding to the accelerations in the adjustment direction and to interpret acceleration values of the acceleration signals in the adjustment direction exceeding a first threshold as presence of a collision.

By the detection of the acceleration in the adjustment direction of the tabletop, the collisions can commonly be detected and determined directly and rapidly.

According to a yet further advantageous implementation of the drive system, the acceleration sensor is configured to the detect accelerations in directions not corresponding to the adjustment direction, and the evaluation unit is configured to evaluate acceleration signals of the acceleration sensor transmitted corresponding to the accelerations in the directions not corresponding to the adjustment direction, and to interpret acceleration values of the acceleration signals corresponding to the accelerations in the directions not corresponding to the adjustment direction, which acceleration values exceed a second threshold, as presence of a collision.

If a collision cannot be recognized directly, an inclined position of the tabletop occurs often after the collision. This tilting can be detected by the acceleration sensors so that, also when the collision is not directly recognized due to a resilient, e.g., elastic, object onto which the tabletop drives, the collision can yet be recognized.

In a further advantageous implementation of the drive system, the drive control device is configured to determine a target speed of the drive device and to transmit it to the evaluation unit, and the evaluation unit is configured to adapt the first and/or second threshold corresponding to the transmitted target speed in order to enable a collision determination also during an intended speed change.

Since the starting and the ending of the height adjustment motion are respectively related to a speed change, therefore, respectively to a (positive or negative) acceleration, there is the risk that this acceleration is recognized as a collision. In order not to block a collision detection during the starting and the ending of the height adjustment motion, the first or second threshold can be adapted such that a collision detection is yet possible.

In a further advantageous implementation of the drive system, the drive system is configured to detect a detected actual speed of the drive device and to transmit it to the evaluation device, and the evaluation device is configured to adjust the threshold corresponding to the transmitted target speed and the transmitted detected actual speed.

The detection of the actual speed supports the collision recognition, for example, during the starting and the ending of the height adjustment since not only the target values are considered but the actual motion of the tabletop directly related to the acceleration sensor without delays in the drive system.

In a further advantageous implementation of the drive system, the drive device, the drive control device, the evaluation unit, and the acceleration sensor are provided integrally.

By the integral design, it's possible to use pre-assembled subassemblies which can be tested and calibrated in advance so that a final assembly is facilitated and accelerated.

According to a further advantageous implementation of the drive system, the drive system comprises a lifting column adjustable in length, and the drive device, the drive control device, the evaluation unit and the acceleration sensor are provided in the lifting column.

By the design in which the drive device, the drive control device, the evaluation unit and the acceleration sensors are provided in the lifting columns, the drive systems can be built in in a space-saving manner. Further, as in the case of the integral design, it is possible to use pre-assembled subassemblies which can be tested and calibrated in advance, whereby the final assembly is facilitated and accelerated.

According to a further aspect of the invention, a table having a height adjustable tabletop comprises several drive systems, wherein a communication connecting cable configured to enable data transmission between the several drive systems is provided between the several drive systems.

Due to the provision of several drive systems, also larger tabletops, particularly with a higher load, can be designed height adjustable. By the communication connecting cable and the thereby possible data transmission, the motions of the drive systems can be synchronized. Thus, a uniform height adjustment of the tabletop is possible.

According to a further aspect of the invention, a method for moving a height adjustable tabletop of a table having a drive system comprises the steps: detecting an acceleration of the sensor motion, transmitting the acceleration signal corresponding to the sensor motion to the evaluation unit, evaluating the acceleration signal by the evaluation unit, determining presence of a collision by means of acceleration values exceeding a threshold, and outputting a collision signal to the drive control device when determining the collision.

By this method, contrary to the force measurement and the measurement of the supply current, the collision can determined already upon a minimum deformation without being delayed by the necessary deformation or compression of additional materials for detecting the collision. Since, also here, no motor current is used for detecting the collision, also the collisions when using other kinds of drives, e.g., a hydraulic drive, can be determined.

According to an advantageous implementation of the method, the evaluation of the acceleration signal comprises an integration in order to estimate an estimated actual speed.

By the integration of the acceleration signal over an elapsed time, the estimated actual speed can be estimated. The change of this estimated actual speed is in turn then used to determine the collision by means of the change of the estimated actual speed.

In a further advantageous implementation of the method, a target speed determined by the drive control device is used in order to adjust the threshold.

Since the starting and the ending of the height adjustment motion are respectively related to a speed change, therefore, respectively related to an acceleration, there is the risk, that this acceleration is recognized as a collision. Therefore, in order not to block a collision detection during the starting and the ending of the height adjustment motion, wherein, a probability of a collision is high hereby, the threshold can be adjusted such that a collision detection is yet possible.

In a further advantageous implementation of the method, an actual speed detected by the drive system is used for adapting the threshold.

The detection of the actual speed detected by the drive device supports the collision detection, for example, during the starting and the ending of the height adjustment, since not only the target values but also the actual motion of the tabletop directly related to the acceleration sensor is considered.

In a further advantageous implementation of the method, the acceleration signals from the acceleration sensors are processed by a filter.

By the provision of the processing of the acceleration signals from the acceleration sensors by a filter, failures in the signals can be eliminated so that a collision can be reliably detected.

In yet another implementation of the method, it comprises the step: transmitting the collision signal from one to the others of the several drive systems.

By the transmission of the collision signal from one drive system to another drive system, the motion of the tabletop can immediately be stopped without the necessity of a subsequent calibration procedure.

### BRIEF DESCRIPTION OF THE SEVERAL VIEWS OF THE DRAWINGS

Subsequently, the invention is elucidated by means of embodiments referring to the attached drawings.

In particular:

FIG. 1 shows a schematic diagram of a height adjustable table having two drive systems according to the invention; and

FIG. 2 shows a block diagram of one of the drive systems.

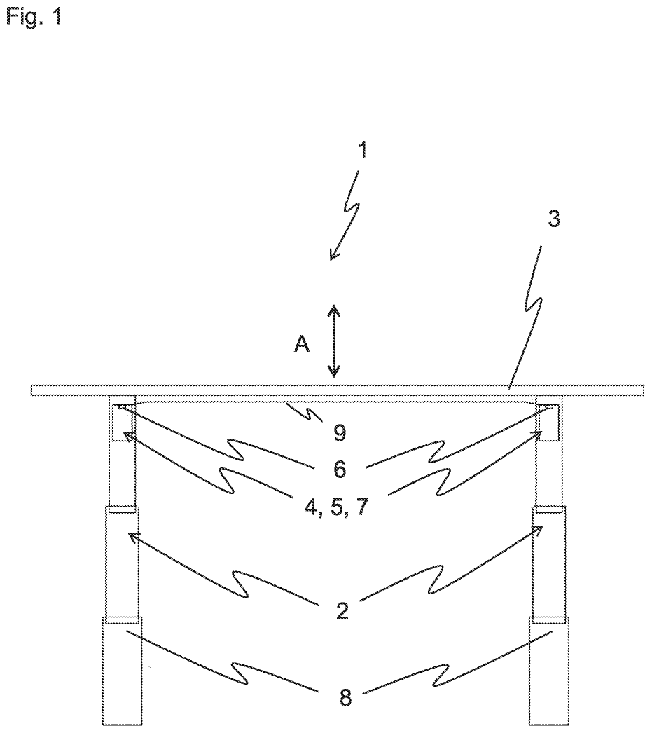

FIG. 1 shows a schematic diagram of a height adjustable table 1 having two drive systems 2 according to the invention.

### DESCRIPTION OF SPECIFIC EMBODIMENTS OF THE INVENTION

The table 1 comprises a height adjustable tabletop 3 connected to the two drive systems 2. In alternative embodiments, the tabletop is not connected to two drive systems 2 but the table comprises merely one single drive system 2 or, in a further alternative, it comprises more than two drive systems 2.

The drive systems 2 respectively comprise a drive device 4, a drive control device 5, an acceleration sensor 6, and an evaluation unit 7.

The drive systems 2 further respectively comprise a lifting column 8 adjustable in length. The lifting column 8 adjustable in length consists of three segments which can be moved into another in a telescopic manner. In alternative embodiments, no lifting column 8 adjustable in length but other guiding members are provided, whereby driving forces of the drive device 4 are transmitted to the tabletop 3 in another manner, for example, via chains or steel bands.

The drive device 4 is configured to move the tabletop 3 in an adjustment direction A. Thereto, in the shown embodiment, the drive device 4 comprises an electric drive motor and a transmission configured to convert a rotational motion of the electric drive motor into a linear motion of the drive device 4. The drive motor comprises control electronics and an incremental position encoder as stroke detection device for detecting a stroke of the drive device 4. In alternative embodiments, the drive device 4 can for example also be designed being a hydraulic cylinder. In alternative embodiments, the control electronics and the incremental position encoder can be replaced by other components for controlling the drive device 4 and being a stroke detection device, for example, a potentiometer.

The acceleration sensor 6 is configured to synchronously follow a motion of the tabletop 3. This means that the acceleration sensor 6 follows a motion of the tabletop 3 immediately. Thereby, the acceleration sensor 6 detects an acceleration of the sensor motion.

The drive control devices 5 of the individual drive systems 2 are connected to one another via a communication connecting cable 9 in order to enable data transmission between the drive systems 2.

The drive device 4, the drive control device 5, the acceleration sensor 6, and the evaluation unit 7 are integrally provided. This means that the drive device 4, the drive control device 5, the acceleration sensor 6 and the evaluation unit 7 are provided as one subassembly. This subassembly is installed in the lifting column 8 and, therefore, it is provided in the lifting column 8. Thereby, the acceleration sensor 6 is arranged on a motor control board of the drive control device 5.

In alternative embodiments, the drive device 4, the drive control device 5, the acceleration sensor 6, and the evaluation unit 7 are not integrally provided but the individual components are arranged at various suitable places of the table. For example, a central drive control device 5 for several drive systems 2 can be provided in a centrally below the tabletop 3 mounted manner. The respective acceleration sensor 6 of the individual drive systems 2 is then not arranged on the motor control board of the drive control device 5 but in another place on the drive device 4 or in close vicinity of a place of fixation of the drive device 4 to the tabletop 3 in order to synchronously follow the motion of the tabletop 3 in this place of fixation. Moreover, in such a case, no communication connecting cable 9 between the individual drive systems 2 is necessary.

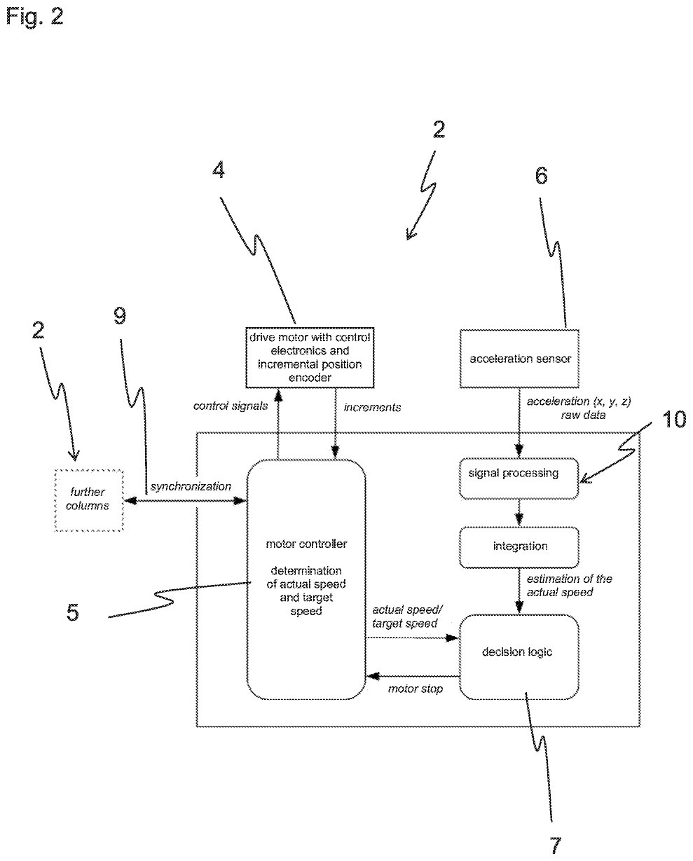

FIG. 2 shows a block diagram of one of the drive systems 2.

The drive device 4 having the electric drive motor with control electronics and integral position encoder are connected to the drive control device 5, in this embodiment, designed as being a motor controller. As far as, in an alternative embodiment, the drive device 4 is not provided with an electric drive motor but, for example, with the hydraulic cylinder, the drive control device 5 is designed as being a hydraulic control device.

The motor controller determines the actual speed and the target speed of the drive motor. This means that the motor controller specifies the target speed of the drive motor and transmits respective control signals to the drive motor, and detects the detected actual speed of the drive motor from increments transmitted from the incremental position encoder of the drive motor to the motor controller. Therefore, the drive control device 5 is configured to control the drive device 4. Thereto, it determines a target speed of the drive device 4 and transmits respective signals to the drive device 4.

Further, the motor controller executes a synchronization with further columns, therefore, with motor controllers of drive control devices 5 of further drive systems 2 via the communication connection cable 9.

The acceleration sensor 6 is configured to detect accelerations in the adjustment direction A of the tabletop 3 and in directions not corresponding to the adjustment direction A. In alternative embodiments, the acceleration sensor 6 is either configured to detect only accelerations in the adjustment direction A of the tabletop 3 or only accelerations in the directions not corresponding to the adjustment direction A. In further alternative embodiments, the acceleration sensor 6 is configured to additionally detect a rotation around at least one axis not being parallel to the adjustment direction A.

The acceleration sensor 6 transmits an acceleration signal corresponding to the sensor motion to the evaluation unit 7. This acceleration signal is transmitted as acceleration (x, y, z) raw data.

This raw data initially enters a signal processing where the acceleration signal from the acceleration sensor 6 is processed by a filter 10 provided in the drive system 2. This filter 10 is designed as being a digital filter in order to eliminate failures. Depending on a configuration of the acceleration sensor 6 and the evaluation unit 7, in alternative embodiments, the filter 10 can also be designed as being an analog filter or it can be omitted.

The raw data processed by the signal processing is integrated in an integration and, therefore, failures are furthermore eliminated and a good estimation of the estimated actual speed is achieved.

The evaluation unit 7 evaluates the acceleration signal from the acceleration sensor 6 by means of a decision logic. Namely, by means of acceleration values exceeding a threshold, the evaluation unit 7 determines that a collision is present. If it is decided that a collision is present, a collision signal, in this case a motor stop signal to the motor controller being the drive control device 5, is output.

Therefore, when the acceleration sensor 6 merely detecting the acceleration signals in the adjustment direction A is provided, the evaluation unit 7 evaluates the acceleration values of the acceleration signals in the adjustment direction A and, as far as the acceleration values exceed a first threshold, the evaluation unit 7 interprets the acceleration signals as presence of a collision.

If another kind of acceleration sensor 6 merely detecting acceleration signals in directions not corresponding to the adjustment direction A is provided, the evaluation unit 7 evaluates the acceleration value of the acceleration signals transmitted corresponding to the accelerations in the directions not corresponding to the adjustment direction A and, as far as they exceed a second threshold, the evaluation unit 7 interprets the acceleration signals as presence of a collision.

The motor controller being the drive control device 5 transmits the determined target speed and the determined actual speed to the decision logic in the evaluation unit 7.

As the case may be, the evaluation unit 7 adapts the first and second threshold corresponding to the transmitted target speed and the transmitted detected actual speed. Thereby, it is possible to perform a collision determination also during an intended speed change, for example, at a starting and at an ending of the height adjustment motion.

In use, in a method for moving an adjustable tabletop 3 of a table 1, the acceleration of the sensor motion of the acceleration sensor 6 is detected. Thereby, the acceleration values in all three space directions are detected with a high detection rate. The detection rate is in the range of 100 Hz to 1000 Hz. Alternatively, other, particularly higher, detection rates are also possible insofar as this is admitted by the calculation capacity of a subsequent processing.

The acceleration signal corresponding to the sensor motion is transmitted to the evaluation unit 7. Thereby, the signal is processed by the digital filter 10 and the subsequent integration such that failures are eliminated in order to achieve an improved estimation of the actual speed. The exact parameters of the signal processing depend on the drive devices and the mechanical design since, depending on that, different kinds of failures can occur. The parameters are adjusted during development or production to a concrete type of drive. Alternatively, the acceleration signals can also be processed by an analog filter 10 or can be directly evaluated.

The processed speed data are evaluated in the decision logic. Thereby, a collision is determined by means of a quick change of the estimated actual speed, therefore, by an acceleration. In particular, the presence of a collision is determined by means of acceleration values exceeding a threshold.

The threshold, therefore, as the case may be, the first threshold and/or the second threshold, are adjusted using the target speed determined by the control device 5. Hereby, it is considered that accelerations occur due to the intended speed change included in the determined target speed, for example, at the starting and at the ending of the height adjustment motion, which accelerations must not influence the determination of the presence of a collision in a negative manner.

Moreover, the threshold, therefore, as the case may be, the first threshold and/or the second threshold are adjusted also using the detected actual speed determined by the drive system 2, wherein the actual speed is determined by the drive control device 5 using the increments detected by the incremental position encoder. Thereby, it is possible to consider the behavior of the drive system 2, particularly delays due to its inertia, during the determination of the presence of a collision.

Alternatively, the determination of the presence of a collision can also be performed without consideration of the determined target speed and the detected actual speed.

Insofar as the presence of a collision is determined, a motor stop signal being a collision signal is emitted to the motor controller in order to immediately stop the drive motor. When several drive systems 2 are used, the motor stop signal is particularly transmitted from one of the drive systems 2 to the other drive systems 2.

All the features represented in the description, the subsequent claims, and the drawing can solitarily or in arbitrary combination be essential for the invention.

What is claimed is:

1. A drive system for moving a height adjustable tabletop of a table, comprising:
a drive device configured to move the tabletop,
a drive control device configured to control the drive device,
an acceleration sensor, and
an evaluation unit,
wherein the acceleration sensor is configured
to synchronously follow a motion of the tabletop,
to detect an acceleration of the sensor motion, and
to transmit an acceleration signal corresponding to the sensor motion to the evaluation unit, and
the evaluation unit is configured
to evaluate the acceleration signal of the acceleration sensor,
to determine presence of a collision by means of acceleration values exceeding a threshold, and
to output a collision signal to the drive control device when the presence of a collision is determined.

2. The drive system according to claim 1, wherein
the drive device comprises an electric drive motor and a transmission configured to convert a rotational motion of the electric drive motor into a linear motion of the drive device.

3. The drive system according to claim 1, wherein,
when a height adjustment of the tabletop happens in an adjustment direction,
the acceleration sensor is configured to detect an acceleration in the adjustment direction, and the evaluation unit is configured to evaluate acceleration signals of the acceleration sensor transmitted corresponding to the accelerations in the adjustment direction, and to interpret acceleration values of the acceleration signals in the adjustment direction exceeding a first threshold as presence of a collision.

4. The drive system according to claim 3, wherein
the acceleration sensor is configured to detect accelerations in directions not corresponding to the adjustment direction, and the evaluation unit is configured to evaluate acceleration signals of the acceleration sensors transmitted corresponding to the accelerations in the directions not corresponding to the adjustment direction, and to interpret acceleration values of the acceleration signals corresponding to the accelerations in the directions not corresponding to the adjustment direction, which acceleration values exceed a second threshold, as presence of a collision.

5. The drive system according to claim 1, wherein
the drive control device is configured to determine and to transmit to the evaluation unit a target speed of the drive device, and the evaluation unit is configured to adjust the first and/or second threshold corresponding to the transmitted target speed in order to enable a collision detection also during an intended speed change.

6. The drive system according to claim 5, wherein
the drive system is configured to detect and to transmit to the evaluation unit a detected actual speed of the drive device, and the evaluation unit is configured to adjust the first and/or second threshold corresponding to the transmitted target speed and the transmitted detected actual speed.

7. The drive system according to claim 1, wherein
the drive device, the drive control device, the evaluation unit, and the acceleration sensor are provided integrally.

8. The drive system according to claim 7, wherein
the drive system comprises a lifting column adjustable in length, and the drive device, the drive control device, the evaluation unit, and the acceleration sensor are provided in the lifting column.

9. A table with a height adjustable tabletop having several drive systems according to claim 1, wherein
a communication connecting cable configured to enable a data transmission between the several drive systems is provided between the several drive systems.

10. A method for moving a height adjustable tabletop of a table having a drive system according to claim 1, having the steps:
detecting an acceleration of the sensor motion;
transmitting the acceleration signal corresponding to the sensor motion to the evaluation unit;
evaluating the acceleration signal by the operation unit;
determining a presence of a collision by means of acceleration value exceeding a threshold; and
outputting a collision signal to the drive control device when determining the collision.

11. The method according to claim 10, wherein
the evaluation of the acceleration signal comprises an integration in order to estimate an estimated actual speed.

12. The method according to claim 11, wherein
a target speed determined by the drive control device is used for adjusting the threshold.

13. The method according to claim 12, wherein
an actual speed detected by the drive system is used for adjusting the threshold.

14. The method according to claim 10, wherein
the acceleration signals from the acceleration sensor are processed by a filter.

15. The method according to claim 10 with a table having several drive systems, having the step:
transmitting the collision signal from one to the other ones of the several drive systems.
